(19) United States
(12) Patent Application Publication
(10) Pub. No.: US 2008/0042974 A1
(43) Pub. Date: Feb. 21, 2008

(54) System and method for determining cursor speed in a puck-based pointing device

(76) Inventors: Todd S. Sachs, Palo Alto, CA (US); Michael J. Brosnan, Fremont, CA (US)

Correspondence Address: Kathy Manke;Avago Technologies Limited, 4380 Ziegler Road, Fort Collins, CO, 80525, US

(21) Appl. No.: 11/506,245

(22) Filed: Aug. 17, 2006

(51) Int. Cl. G09G 5/08

(52) U.S. Cl. 345/157

(57) ABSTRACT

A pointing device includes a moveable puck, a first surface on which a puck field of motion is defined, and a controller. The total distance the puck can move from its centered or resting position is divided into N regions using one or more transition points. Each transition point corresponds to a puck position at which the cursor speed changes. The controller determines the position of the puck within the puck field of motion and, based on the current puck position and at least one transition point, the controller determines a speed at which the cursor is to be moved.

### BACKGROUND

Modern operating systems and application programs for data processing devices such as, for example, computers, cell phones, gaming systems, digital video recorders, and personal digital assistants, require a pointing device for controlling the position of a cursor on a display. For computers, one successful pointing device is the “mouse”. A mouse is a handheld object that is moved over a flat surface to control the motion of a cursor on the display. The direction and distance over which the mouse is moved determines the direction and distance the cursor moves on the display. A conventional mouse provides a rigid object that a user can move with great precision.

While the mouse has provided a satisfactory solution to the pointing device problem in the desktop computer market, a similarly successful device is not available for portable and handheld devices. The Synaptics capacitive TouchPad™ and the IBM TrackPoint™ are examples of pointing devices currently used with portable and handheld devices. The TrackPoint™ is a small button typically placed in the center of a laptop computer keyboard. The button is moved in a manner analogous to a “joystick” by applying a lateral force to the top of the button with a finger.

The TouchPad™ is a blank pad, typically rectangular in shape that is placed in front of the keyboard on most laptop computers. The device senses the position of a finger on the surface of the rectangular pad relative to the edges of the pad by measuring the capacitance changes introduced by the finger on a series of electrodes beneath an insulating, low-friction material.

Unfortunately, both the TouchPad™ and the TrackPoint™ suffer from a lack of precision. The contact area of the user's finger is relatively large with respect to the overall size of the TouchPad™. Additionally, the contact area varies in size and shape with the pressure applied by the user. Therefore, to provide an accurate measurement of the finger position, the device must determine some parameter such as the center of the contact area between the finger and the pad. Such determinations are, at best, of limited precision.

Similarly, a user can only move a TrackPoint™ a small distance. Hence the displacement of the button cannot be mapped directly into a displacement in the cursor position on a display. Instead, the button displacement controls the direction and speed of the movement of the cursor. The accuracy with which a user can position the cursor with the TrackPoint™ button is significantly less than that achieved with a conventional mouse.

In previously filed U.S. patent application Ser. No. 10/723,957 filed on Nov. 24, 2003, which is hereby incorporated by reference, an improved pointing device for handheld and portable devices is described. The pointing device utilizes a puck that moves in a defined field of motion when a user applies pressure to the puck via the user's finger. Changes in the position of the puck move a cursor on a display using a linear relationship between the position of the puck and a cursor speed. The distance of the puck from its center or resting position is mapped linearly to the speed of the cursor. Unfortunately, this implementation has dynamic range limitations. The speed at which the cursor moves on the display can be to fast when a user is selecting an icon or a feature located at the edge of the display. Alternatively, the speed at which the cursor moves on the display can be too slow when a user is playing a game and the cursor needs to be move quickly in a number of different directions.

### SUMMARY

In accordance with the invention, a method and system for determining cursor speed in a puck-based pointing device are provided. A pointing device includes a moveable puck, a first surface on which a puck field of motion is defined, and a controller. The total distance the puck can move from its centered or resting position is divided into N regions using transition points. Each transition point corresponds to a puck position at which the speed of the cursor changes. The controller determines the position of the puck within the field of motion and, based on the current puck position and at least one transition point, the controller determines a speed at which the cursor is to be moved. The cursor speed is determined with a mathematical equation that includes one or more transition points or the current puck position to determine cursor speed in one embodiment in accordance with the invention.

In another embodiment in accordance with the invention, the cursor speed is determined by interpolation between the cursor speeds defined at the two transition points nearest the current puck position. And in yet another embodiment in accordance the invention, one or more cursor speed profiles are pre-computed and stored in memory. Each cursor speed profile includes several different puck positions and their associated cursor speeds. A particular cursor speed profile is selected and used to determine cursor speed as the puck moves within its field of motion.

### BRIEF DESCRIPTION OF THE DRAWINGS

FIG. 1A illustrates a top view of a pointing device in an embodiment in accordance with the invention;

FIG. 1B is a cross-sectional view of the pointing device shown in FIG. 1A through line 1B-1B;

FIG. 2 illustrates an equivalent circuit formed by electrodes 124, 126, 128 shown in FIG. 1B;

FIG. 3 is a top view of a portion of surface 104 shown in FIG. 1 over which a puck moves in an embodiment in accordance with the invention;

FIG. 4 is a schematic drawing of an equivalent circuit for electrodes 302, 304, 306, 308 shown in FIG. 3;

FIG. 5 is a block diagram of controller 400 shown in FIG. 4 in an embodiment in accordance with the invention;

FIG. 6 is a flowchart of a first method for determining cursor speed in an embodiment in accordance with the invention;

FIG. 7 is a graphical illustration of a first user interface that can be used to program one or more transition points in an embodiment in accordance with the invention;

FIG. 8 is a graphical illustration of a second user interface that can be used to program one or more transition points in an embodiment in accordance with the invention;

FIG. 9 is a first plot that can be used to determine cursor speed in an embodiment in accordance with the invention;

FIG. 10 is a second plot that can be used to determine cursor speed in an embodiment in accordance with the invention;

FIG. 11 is a flowchart of a second method for determining cursor speed in an embodiment in accordance with the invention; and

FIG. 12 is a flowchart of a third method for determining cursor speed that is used with the second method shown in FIG. 11.

### DETAILED DESCRIPTION

The following description is presented to enable embodiments of the invention to be made and used, and is provided in the context of a patent application and its requirements. Various modifications to the disclosed embodiments will be readily apparent, and the generic principles herein may be applied to other embodiments. Thus, the invention is not intended to be limited to the embodiments shown but is to be accorded the widest scope consistent with the appended claims. Like reference numerals designate corresponding parts throughout the figures.

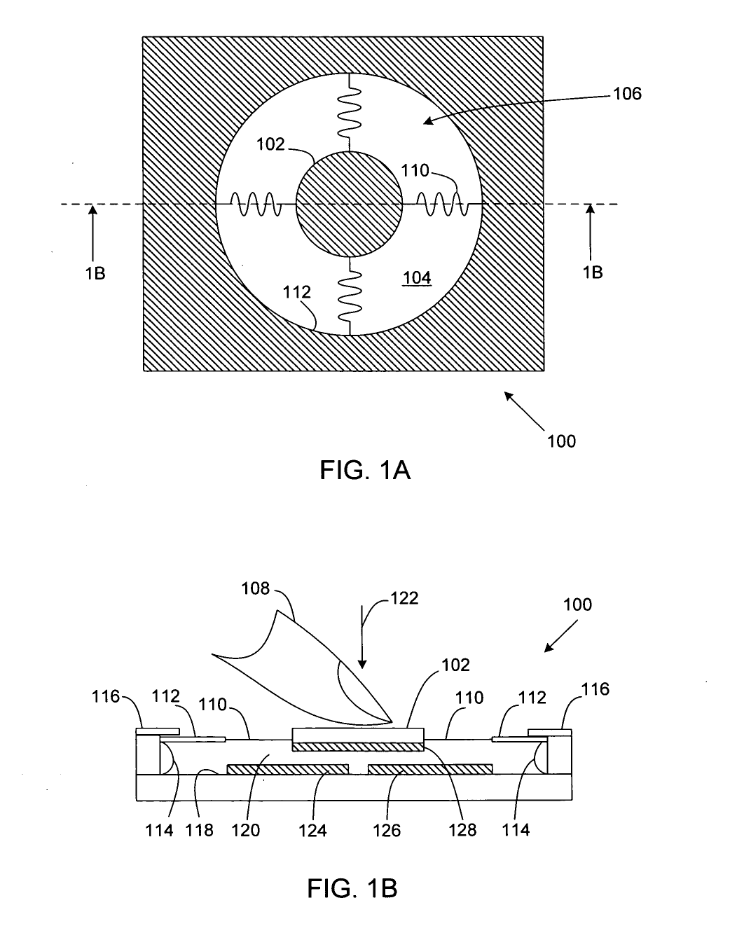

FIG. 1A illustrates a top view of a pointing device in an embodiment in accordance with the invention. Pointing device 100 includes puck 102 that moves over surface 104 within a puck field of motion 106 in response to a lateral force applied to puck 102. The force is typically applied to puck 102 by a user's finger, finger tip, thumb, thumb tip or multiple fingers (108 in FIG. 1B). Pointing device 100 includes a pressure sensing mechanism that measures the vertical pressure applied to puck 102 and a position sensing mechanism for determining the position of puck 102 within the puck field of motion 106 in an embodiment in accordance with the invention.

When a user applies a vertical force to puck 102 that is greater than a predetermined threshold, any change in the position of puck 102 over surface 104 is reported to a host device (not shown). This change in position moves a cursor on a display (not shown) by a magnitude and direction using techniques that are described in conjunction with FIGS. 4-12. When a user applies a vertical force to puck 102 that is greater than another predetermined threshold value, the user has performed a “clicking” operation that is reported to a host device (not shown).

When the user releases puck 102 by removing his or her finger (108 in FIG. 1B), puck 102 is returned to its centered position by springs 110 that connect puck 102 to edge plate 112. Since the user's finger is not applying a vertical force to puck 102 during its return to the center position, the change in motion is not reported to the host device. This provides a convenient “re-centering” capability typically achieved on a mouse by lifting and replacing the mouse to the center of the field of motion. This re-centering capability is useful with laptop computers, handheld devices and other miniature apparatus in which the field of motion is constrained.

FIG. 1B is a cross-sectional view of the pointing device shown in FIG. 1A through line 1B-1B. Edge plate 112 has an opening that allows springs 110 to connected puck 102 to edge plate 112 and define the puck field of motion 106. Springs 110 return puck 102 to a predetermined location within the puck field of motion when puck 102 is released by the user. One example of a predetermined location within the puck field of motion is the center. Springs 114 maintain the position of edge plate 112 against detent 116.

Puck 102 moves toward the bottom 118 of cavity 120 when finger 108 applies a downward force to puck 102 in the direction shown by arrow 122. The vertical pressure applied to puck 102 and the position of puck 102 within the puck field of motion 106 can be sensed by any of a number of methods. One such pressure sensing mechanism senses the capacitance between electrodes 124, 126 and puck electrode 128 to provide a measurement of the distance between puck 102 and bottom 118. The measured capacitance between electrodes 124, 126 and puck electrode 128 is also used to determine the position of puck 102 within the puck field of motion 106.

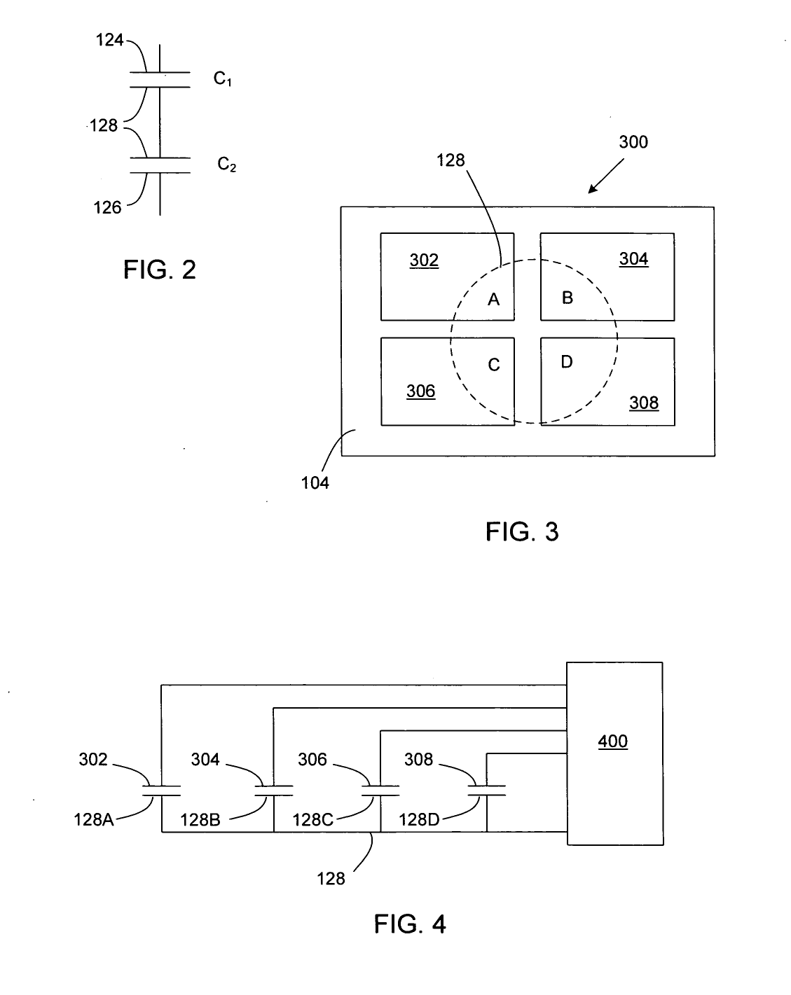

FIG. 2 illustrates an equivalent circuit formed by electrodes 124, 126, 128 shown in FIG. 1B. Electrodes 124, 126, 128 form an electrical circuit that is equivalent to two capacitors connected in series with puck electrode 128 as the common electrode. Capacitor C₁ represents the capacitance between electrodes 124 and 128 while capacitor C₂ represents the capacitance between electrodes 126 and 128. The total capacitance between electrodes 124 and 126 depends on the distance between puck electrode 128 and electrodes 124, 126 and an amount of overlap between puck electrode 128 and electrodes 124, 126. This total capacitance can be sensed with the aid of external electrical connections to electrodes 124, 126, which have been omitted from FIG. 2 for the sake of simplicity. This capacitance measuring scheme does not require an external electrical connection to puck electrode 128, and therefore is inexpensive and simple in its implementation. However, other embodiments in accordance with the invention may measure the capacitance between puck electrode 128 and one or both of electrodes 124 and 126.

While the above-described pointing device embodiment utilizes capacitive measurements for sensing the distance between the moveable element and the bottom 118 of cavity 120 and the position of puck 102 within the puck field of motion 106, other embodiments in accordance with the invention can use different position sensing mechanisms. By way of example only, the position of puck 102 in the puck field of motion 106 can be ascertained using optical sensors such as those used in a conventional optical mouse.

An embodiment of a position detector 300 that detects the position of a puck on an underlying surface may be more easily understood with reference to FIG. 3. FIG. 3 is a top view of a portion of surface 104 shown in FIG. 1 over which a puck moves in an embodiment in accordance with the invention. Underlying surface 104 includes four electrodes 302, 304, 306, 308 that have terminals (not shown) connected to an external circuit (not shown). Embodiments in accordance with the invention are not limited to the use of four electrodes 302, 304, 306, 308. Any given number of electrodes can be used.

Puck 102 has a bottom surface that includes puck electrode 128, which is shown in phantom in FIG. 3: Electrodes 302, 304, 306, 308 are electrically isolated from one another. For example, puck electrode 128 can be covered with a layer of dielectric material to provide the required insulation while still allowing puck electrode 128 to slide over electrodes 302, 304, 306, 308. Electrodes 302, 304, 306, 308 are patterned on underlying surface 300 in an embodiment in accordance with the invention. This reduces the capacitance between electrodes 302, 304, 306, 308 and puck electrode 128, but can be practical for a substrate thickness of a few millimeters or less. The overlap between puck electrode 128 and each of electrodes 302, 304, 306, 308 depends on the position of the puck relative to electrodes 302, 304, 306, 308. The overlaps between puck electrode 128 and electrodes 302, 304, 306, 308 are denoted in FIG. 3 by the letters A, B, C, D, respectively.

Referring now to FIG. 4, there is shown a schematic drawing of an equivalent circuit for electrodes 302, 304, 306, 308 shown in FIG. 3. The portion of puck electrode 128 that overlaps electrode 302 forms a parallel plate capacitor that has a capacitance that is proportional to overlap A. Similarly, the portion of puck electrode 128 that overlaps electrode 304 forms a parallel plate capacitor that has a capacitance that is proportional to overlap B, as so on. Since all of the capacitors share portions of puck electrode 128 in FIG. 3, the equivalent circuit includes the four capacitors connected to common puck electrode 128.

The position of puck electrode 128 relative to electrodes 302, 304, 306, 308 is determined by measuring the capacitance between puck electrode 128 and each electrode 302, 304, 306, 308. This determination is made by controller 400 in an embodiment in accordance with the invention. Controller 400 may be included in a pointing device (e.g., 100 in FIG. 1) or may be included in a host device (not shown) that includes pointing device 100.

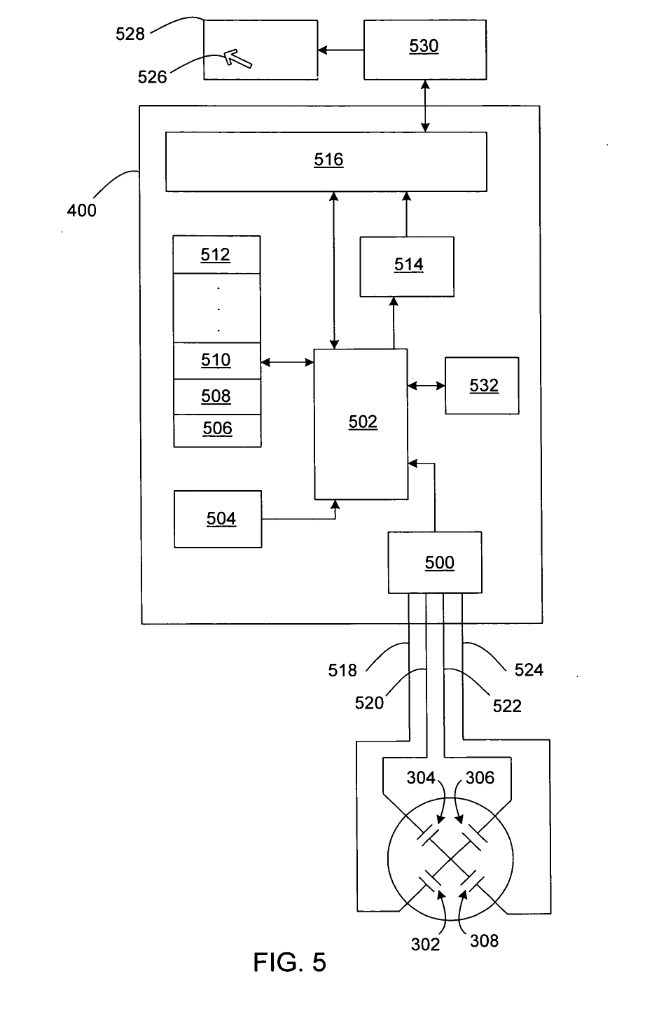

FIG. 5 is a block diagram of controller 400 shown in FIG. 4 in an embodiment in accordance with the invention. Controller 400 includes analog interface 500, pointing device microprocessor 502, static memory 504, registers 506, 508, 510, 512, motion buffer 514, and input/output component 516. A capacitance value for each electrode 302, 304, 306, 308 is received by analog interface 500 via input lines 518, 520, 522, 524, respectively. Analog interface 500 converts the capacitance measurements into representative digital values.

Pointing device microprocessor 502 receives the representative digital values and determines the position of puck 102 within the puck field of motion using navigation firmware stored in static memory 504. The representative digital values relative to each other are analyzed to determine the position of puck 102. Using the determined position of the puck, pointing device microprocessor 502 determines a cursor speed for cursor 526 shown on host display 528.

To determine the appropriate speed for cursor 526, pointing device microprocessor 502 accesses transition points stored in registers 506, 508, 510, 512. Registers 506, 508, 510, 512 store different transition points that correspond to puck positions at which the cursor speed for cursor 526 changes. The ellipses between register 510 and register 512 indicate that any number of registers may be included in controller 400. The transition points divide the distance the puck can move from its centered or resting position into (N+1) regions, where N is the total number of transition points.

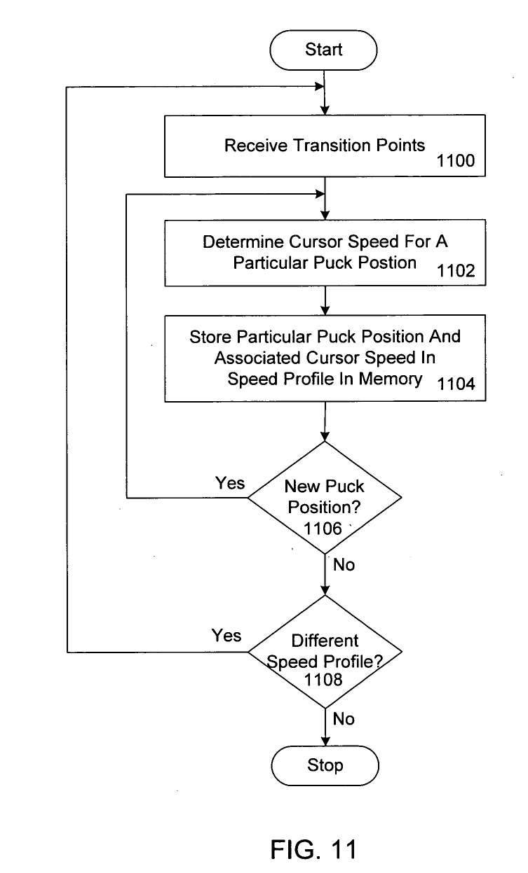

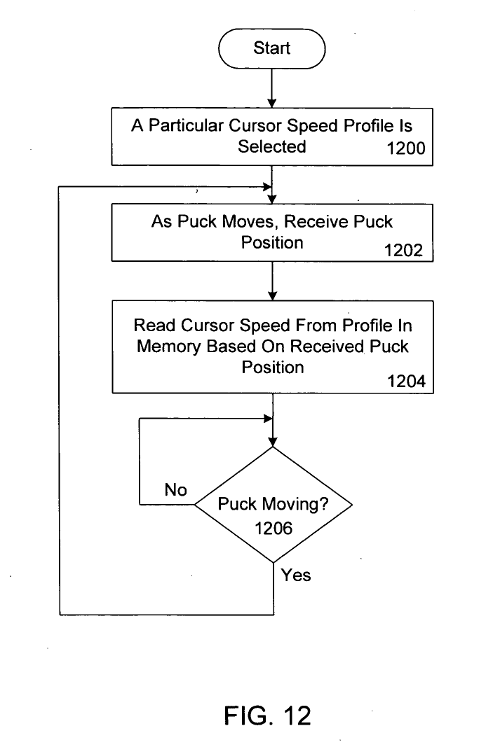

Thus, the change in cursor speed for each transition point can be customized based on the number of registers in an embodiment in accordance with the invention. The reasons to customize cursor speed include, but are not limited to, the type of portable or handheld device, the type of programs used on a device, and the size of the display. Other embodiments in accordance with the invention may store the transition points or data relating to the speed of a cursor differently. For example, memory 532 in controller 400 can store pre-calculated cursor speeds for various puck positions. This technique is described in more detail in conjunction with FIGS. 11 and 12.

The position and speed of cursor 526 can be stored in optional motion buffer 514 prior to being received by input/output component 516. Input/output component 516 transfers the position and speed values to host microprocessor 530, which in turn may change the position, the speed, or both the position and speed of cursor 526 in response to receiving the values from controller 400.

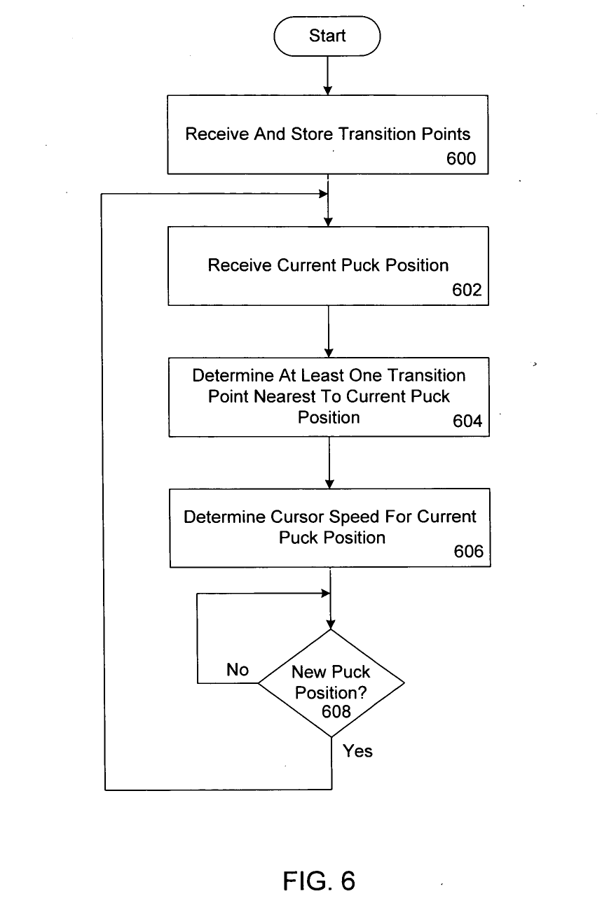

Referring now to FIG. 6, there is shown a flowchart of a first method for determining cursor speed in an embodiment in accordance with the invention. Initially the transition points are received and stored, as shown in block 600. As described earlier, the transition points are the puck positions at which the speed of the cursor changes. The transition points can be received using one of several different techniques. A host microprocessor (530 in FIG. 5) can write the transition points to input/output component 516, thereby allow pointing device microprocessor 502 to write the values into registers 506, 508, 510, 512. This technique is used by the host device manufacturer in an embodiment in accordance with the invention.

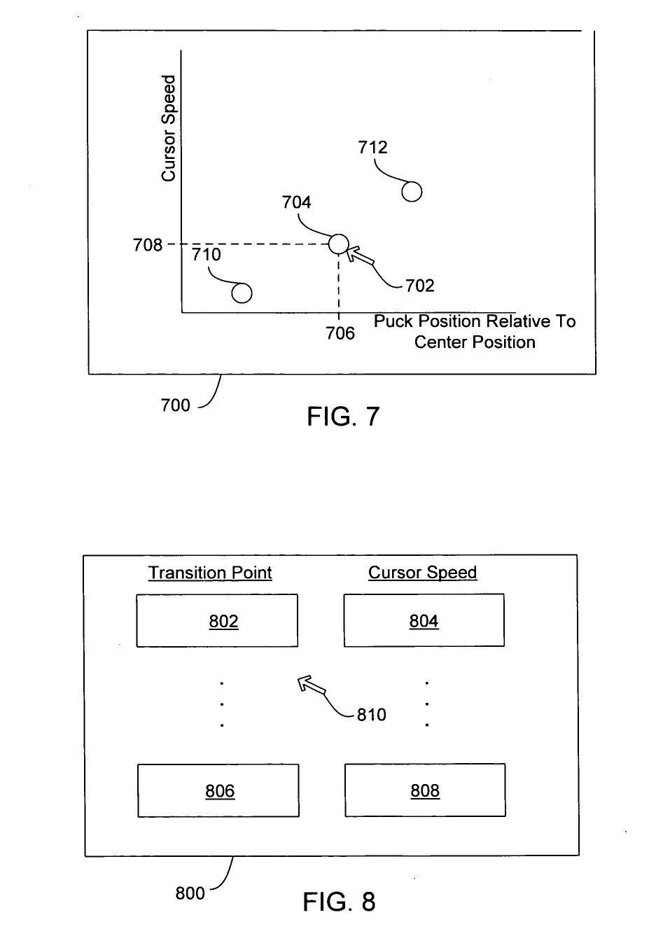

In another embodiment in accordance with the invention, a user may program some or all of the transition points, or re-program some or all of the default transition points set by the device manufacturer, using a user interface. FIG. 7 is a graphical illustration of a first user interface that can be used to program one or more transition points in an embodiment in accordance with the invention. Host display 700 displays a graph having an x-axis representing the puck position relative to its center or resting position and a y-axis representing cursor speed. Using cursor 702, the user “clicks” on location 704 to set a transition point in an embodiment in accordance with the invention. Based on selected location 704, the puck position reflected on the x-axis 706 is a transition point and the cursor speed is determined from the y-axis 708. In another embodiment in accordance with the invention, display 700 displays transition points 710, 704, 712 and the user moves some or all of the transition points to desired locations using cursor 702.

FIG. 8 is a graphical illustration of a second user interface that can be used to program one or more transition points in an embodiment in accordance with the invention. Host display 800 displays boxes 802, 804, 806, 808. The ellipses indicate any given number of boxes may be shown on display 800. Each box 802, 804, 806, 808 is a pull-down menu in an embodiment in accordance with the invention. Each pull-down menu on the left side of the screen (i.e., boxes 802, 806) displays different transition points a user can select using cursor 810. Each pull-down menu on the right side of the screen (i.e., boxes 804, 808) displays different cursor speeds a user can select using cursor 810. Once a transition point has been selected in a given transition point box, the corresponding cursor speed box may display only those cursor speed values that are available for the selected transition point. In another embodiment in accordance with the invention, boxes 802, 804, 806, 808 are dialog boxes for entering data into in order to program each transition point and associated cursor speed.

Returning now to FIG. 6, after the transition points have been stored at block 600, the current puck position is received from the pointing device microprocessor. This step is shown in box 602. At least one transition point nearest to the current puck position is then determined at block 604. Using the one or more transition points, the cursor speed is determined at block 606. For example, in one embodiment in accordance with the invention, a straight line that intersects the current puck position is generated between the two nearest transition points, thereby creating a piecewise linear relationship between the transition points and the speed of the cursor.

In another embodiment in accordance with the invention, a curve that includes all of the transition points is generated using interpolation. And in yet another embodiment in accordance with the invention, the pointing device microprocessor calculates the cursor speed using any given mathematical equation.

A determination is then made at block 608 as to whether the puck has been moved to a new position. If not, the method waits until the puck is moved. When the puck has been moved to a new position, the process returns to block 602 and repeats for each new puck position.

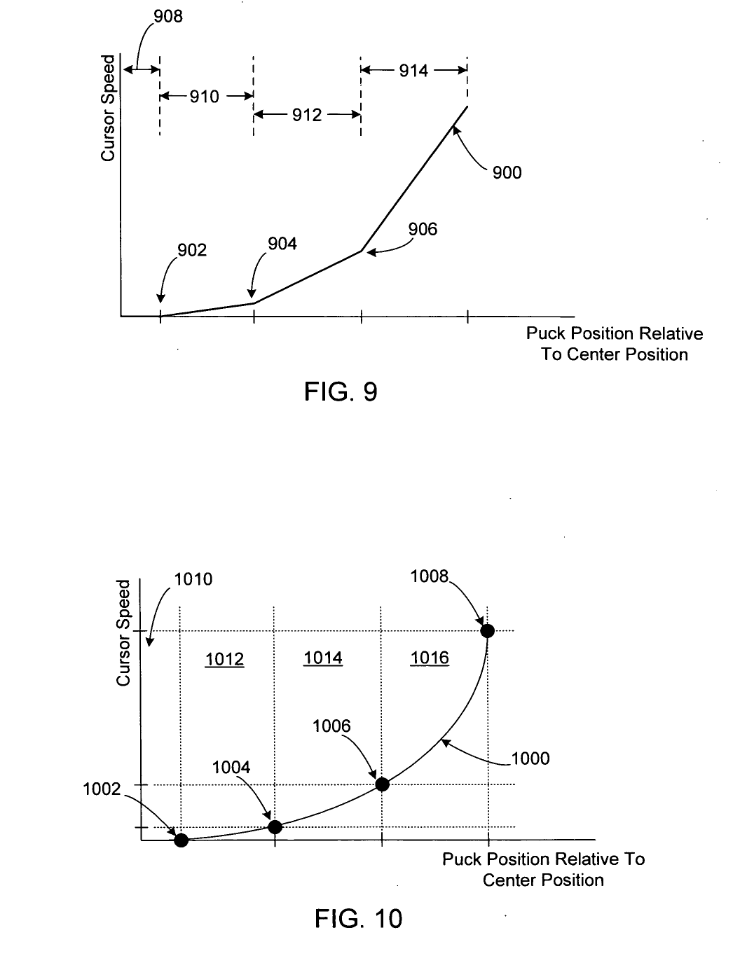

FIG. 9 is a first plot that can be used to determine cursor speed in an embodiment in accordance with the invention. Plot 900 is generated by the pointing device microprocessor (502 in FIG. 5) and includes three transition points 902, 904, 906 in an embodiment in accordance with the invention. The puck is in its centered or resting position at the point where the x-axis and y-axis intersect. Between that point and transition point 902 the cursor speed is zero. This area is called a “dead zone” because the cursor does not move for small changes in puck position, such as when a user is simply resting his or her finger on the puck.

The three transition points 902, 904, 906 divide the total distance the puck can move from its center position into four regions 908, 910, 912, 914. Each region has a line generated between the two boundary transition points, but the slope of the lines differ in each region. The different slopes correspond to different cursor speeds in an embodiment in accordance with the invention.

A line having one particular slope is generated between transition points 902, 904 by the pointing device microprocessor. When the puck position relative to its centered or resting position is between transition points 902, 904, the cursor speed accelerates according to the linear relationship between points 902, 904. A line having a different slope is generated between transition points 904, 906 so that when the puck position relative to its centered or resting position is between these transition points 904, 906 the cursor speed accelerates faster than the previous rate of acceleration. And a line having another different slope is generated between transition point 906 and the maximum puck position. When the puck position relative to its center position is beyond transition point 906, the cursor speed accelerates faster than the two previous rates of acceleration.

FIG. 10 is a second plot that can be used to determine cursor speed in an embodiment in accordance with the invention. Plot 1000 represents the total cursor speeds for the distances the puck moves from its centered or resting position. Plot 1000 includes three transition points 1002, 1004, 1006 and point 1008, which represents a maximum cursor speed for a maximum puck position. The three transition points 1002, 1004, 1006 divide the total distance the puck can move from its centered or resting position into four regions 1010, 1012, 1014, 1016. The pointing device microprocessor (502 in FIG. 5) calculates the speed of the cursor for a particular puck position by interpolating between the cursor speeds defined by the two boundary transition points nearest the current puck position. Interpolation typically causes plot 1000 to assume a curved shape. This method results in a smoother and substantially constant rate of acceleration for the cursor speed because the acceleration is based on a curve. The curve eliminates the sudden changes in speed that can occur at the transition points 902, 904, 906 shown in FIG. 9.

Embodiments in accordance with the invention are not limited to the number of transition points and the shape of plots 900, 1000 shown in FIG. 9 and FIG. 10, respectively. Other embodiments in accordance with the invention can use any given number of transition points. Moreover, the shape of a plot can assume any given shape. This provides flexibility and allows the plot to be customized for any reason, such as the type of portable or handheld device, the type of programs used on a device, and the size of the display.

Referring now to FIG. 11, there is shown a flowchart of a second method for determining cursor speed in an embodiment in accordance with the invention. Initially, the transition points are received, as shown in block 1100. By way of example only, the transition points can be received using the techniques described in conjunction with FIGS. 7 and 8.

A cursor speed associated with a particular puck position is then determined at block 1102. The cursor speed can be determined using, for example, the techniques described in FIGS. 9 and 10. The particular puck position and its associated cursor speed are then stored in a cursor speed profile that is stored in memory (block 1104). For example, the puck positions and associated cursor speeds in a profile may be stored in a database or look-up table.

A determination is then made at block 1106 as to whether a new puck position is to be processed for the current cursor speed profile. If so, the method returns to block 1102 and repeats for all desired puck positions. When all of the desired puck positions and their associated cursor speeds have been stored to complete the current cursor speed profile, a determination is made at block 1108 as to whether a different cursor speed profile is to be generated. If so, the process returns to block 1102 until all desired speed profiles have been created.

The cursor speed profiles allow a system to customize the cursor speeds based on the type of handheld or portable device in use or for different application programs. A user can then select a cursor speed profile in an embodiment in accordance with the invention. For example, a user can select one cursor speed profile when the user is using a word processing program and select a different cursor speed profile for a game program. A game program typically requires faster cursor speeds than a word processing program.

In another embodiment in accordance with the invention, an operating system running on a device can variably select cursor speed profiles based on the actions taken by a user. For example, one cursor speed profile can be implemented by the host device when the user is selecting icons or options displayed on a menu. The host device then selects a different cursor speed profile when the user launches a game program.

And in yet another embodiment in accordance with the invention, the cursor speed profiles are set by a device manufacturer as default profiles. The user can then change those profiles using a user interface in an embodiment in accordance with the invention.

FIG. 12 is a flowchart of a third method for determining cursor speed that is used with the second method shown in FIG. 11. Initially, a cursor speed profile is selected, as shown in box 1200. As discussed earlier, the cursor speed profile may be set by a manufacturer, selected by a user, or selected by an operating system based on the actions taken by the user.

When the puck position changes, the new puck position is received by the pointing device microprocessor (502 in FIG. 5) in an embodiment in accordance with the invention. This step is shown at block 1202. The pointing device microprocessor then reads the cursor speed associated with the puck position from memory (block 1204). If a cursor speed is not associated with the exact position of the puck, the pointing device microprocessor can determine a cursor speed using one of several techniques. For example, in one embodiment in accordance with the invention, the pointing device microprocessor can select a speed based on a stored puck position that is nearest the current puck position. Other techniques, such as interpolation, can be used in other embodiments in accordance with the invention.

A determination is then made at block 1206 as to whether the puck is still moving. If not, the method waits until the puck is moved by the user. When the puck is moved, the process returns to block 1202 and repeats whenever the user moves the puck. In practice, the pointing device microprocessor receives a number of puck position determinations every minute. For example, in one embodiment in accordance with the invention, the pointing device microprocessor receives 100 puck position determinations each minute.

1. A pointing device for use with a data processing device, wherein the pointing device is used to manipulate a cursor shown on a display associated with the data processing device, the pointing device comprising:
a first surface having a puck field of motion defined thereon;
a moveable puck operable to move within the puck field of motion, wherein a total distance the moveable puck can move within the field of motion is divided into N regions, where N is based on one or more transition points within the puck field of motion where each transition point corresponds to a puck position at which the cursor speed is changed; and
a controller operable to determine a position of the moveable puck within the puck field of motion and, based on the puck position, determine a cursor speed for moving the cursor shown on the display, wherein the cursor speed is based on which of the N regions the puck position is located.

2. The pointing device of claim 1, wherein the moveable puck comprises a puck electrode on a second surface on the puck that is parallel to the first surface, wherein the first surface comprises a plurality of electrodes that are parallel to the puck electrode and the puck electrode overlies a portion of each of the electrodes in the plurality of electrodes.

3. The pointing device of claim 2, wherein the controller is operable to receive a plurality of values each representing a measured capacitance between the puck electrode and a respective electrode in the plurality of electrodes.

4. The pointing device of claim 1, further comprising one or more registers, wherein each register stores a respective transition point.

5. The pointing device of claim 1, further comprising a memory for storing the one or more transition points.

6. The pointing device of claim 1, further comprising a memory for storing one or more cursor speed profiles, wherein each cursor speed profile includes one or more particular puck positions and a respective cursor speed that is associated with each particular puck position.

7. A method for determining a cursor speed for a cursor shown on a display in a puck-based pointing device, wherein the puck is moveable within a puck field of motion that is divided into N regions where N is based on one or more transition points that each correspond to a puck position at which the cursor speed is changed, the method comprising:
determining a position for the puck; and
determining a cursor speed for moving the cursor shown on the display, wherein the cursor speed is based on which of the N regions the puck position is located.

8. The method of claim 7, further comprising moving the cursor shown on the display at the determined cursor speed in response to a change in the position of the puck from a previously determined position.

9. The method of claim 7, further comprising programming the one or more transition points.

10. The method of claim 9, wherein programming the one or more transition points comprises receiving each of the one or more transition points.

11. The method of claim 9, wherein programming the one or more transition points comprises using a user interface shown on the display to select one or more transition points.

12. The method of claim 7, wherein determining a cursor speed for moving the cursor shown on the display comprises interpolating between a cursor speed defined by each of two boundary transition points nearest the determined puck position.

13. The method of claim 7, wherein determining a cursor speed for moving the cursor shown on the display comprises:
generating a line between each of two boundary transition points nearest the determined puck position; and
determining the cursor speed for moving the cursor shown on the display based on a location on the line associated with the puck position.

14. The method of claim 7, wherein determining a cursor speed for moving the cursor shown on the display comprises calculating a cursor speed from a particular mathematical equation that includes one or more transition points and the current puck position to determine the cursor speed for moving the cursor shown on the display.

15. A method for determining a cursor speed for a cursor shown on a display in a puck-based pointing device, wherein the puck is moveable over a distance that includes one or more transition points that each correspond to a puck position at which the cursor speed is changed, the method comprising:
receiving a current puck position; and
determining a cursor speed associated with the current puck position, wherein the cursor speed is based on at least one transition point that is nearest in distance to the current puck position.

16. The method of claim 15, wherein determining a cursor speed associated with the current puck position comprises reading a cursor speed associated with the current puck position from a cursor speed profile, wherein the cursor speed profile includes one or more different puck positions and each puck position is associated with a respective cursor speed.

17. The method of claim 15, further comprising repeatedly receiving a current puck position and determining a cursor speed associated with the current puck position.

18. The method of claim 15, further comprising receiving the one or more transition points.

19. The method of claim 18, wherein receiving the one or more transition points comprises receiving one or more user-input transition points.
